(19) United States
(12) Patent Application Publication
(10) Pub. No.: US 2024/0208465 A1
(43) Pub. Date: Jun. 27, 2024

(54) SENSOR FIELD CLEANING DEVICE, SENSOR, VEHICLE AND METHOD

(71) Applicant: Robert Bosch GmbH, Stuttgart (DE)

(72) Inventors: Gyorgy Szabo, Budapest (HU); Akos Hegyi, Mezöhegyes (HU); Bence Balint, Monor (HU); Janos Simonovics, Dunaharaszti (HU); Mate Hornyak, Pakozd (HU); Peter Deak, Budapest (HU); Zoltan Gyonyoru, Budapest (HU)

(21) Appl. No.: 18/544,978

(22) Filed: Dec. 19, 2023

(30) Foreign Application Priority Data
Dec. 23, 2022 (DE) 10 2022 214 377.9

(51) Int. Cl. B60S 1/04; G01S 7/481

(52) U.S. Cl. CPC B60S 1/04; G01S 7/4811

(57) ABSTRACT

A sensor field cleaning device (10a; 10b; 10c; 10d; 10e; 10f) for cleaning at least one sensor (12a; 12b; 12c; 12d; 12e; 12f), in particular a driving assistance sensor, for example a LiDAR sensor, of a vehicle (14a; 14b; 14c; 14d; 14e; 14f). The device includes a wiper unit (16a; 16b; 16c; 16d; 16e; 16f) which comprises at least one wiper (18a; 18b; 18c; 18d; 18e; 18f). The wiper unit (16a; 16b; 16c; 16d; 16e; 16f) is configured to clean an at least singly-curved sensor field surface (20a; 20b; 20c; 20d; 20e; 20f) of the sensor (12a; 12b; 12c; 12d; 12e; 12f) by a back-and-forth movement of the wiper (18a; 18b; 18c; 18d; 18e; 18f).

### BACKGROUND

A sensor field cleaning device for cleaning at least one sensor, with a wiper unit comprising at least one wiper, has already been proposed.

### SUMMARY

The invention is based on a sensor field cleaning device for cleaning at least one sensor, in particular a driving assistance sensor, e.g. a LiDAR sensor, of a vehicle, with a wiper unit comprising at least one wiper.

It is proposed that the wiper unit is configured to clean an at least single-curved sensor field surface of the sensor by means of a back-and-forth movement of the wiper, in particular at least mechanically, preferably directly.

The design of the sensor field cleaning device according to the invention can advantageously enable and preferably ensure safe operation of sensors with curved sensor field surfaces, in particular by enabling cleaning of single-curved sensor field surfaces. Advantageously, a safety can be improved, since in particular a cleaning from the curved sensor field surface prevents a malfunction from the sensor, in particular LiDAR sensor.

Preferably, the sensor comprises a sensor field that comprises an at least single-curved sensor field surface, in particular one that is convex when viewed from the outside. Preferably, the curvature extends around exactly one axis of curvature. Preferably, the axis of curvature extends at least substantially perpendicular to the back-and-forth movement and/or at least substantially parallel to a main direction of extension from the wiper. Preferably, the axis of curvature is oriented at least substantially parallel to a vertical direction. It is conceivable that the curvature is at least biaxial. For example, the sensor field surface could be arranged about the axis of curvature in the vertical direction and another axis of curvature arranged at least substantially parallel to a horizontal direction. In particular, a radius of curvature of the sensor field surface is designed to be variable along the back-and-forth movement of the wiper. It is also conceivable that the radius of curvature is constant. It is conceivable that the curvature is designed as an S-shape and/or as a waviness. The term “main direction of extension” of an object is in this context in particular understood to mean a direction which extends parallel to a longest edge of a smallest geometrical cuboid, which just completely surrounds the object. In particular, the term “vertical direction” is to be understood to mean a direction that extends parallel to a gravitational direction.

The term “substantially horizontal” is in this context intended in particular to define an orientation of a direction relative to a horizontal reference direction, whereby direction and the horizontal reference direction enclose an angle of 0°, in particular as viewed in a projection plane, and the angle featuring a maximum deviation of in particular less than 8°, advantageously less than 5° and particularly advantageously less than 2°. The term “horizontal reference direction” is in particular understood to mean a direction which extends perpendicular to a direction of gravity. The term “substantially perpendicular” is understood in particular to mean an orientation of a direction relative to a reference direction, whereby the direction and the reference direction, in particular as viewed in a projection plane, enclose an angle of 90°, and the angle features a deviation of in particular less than 8°, advantageously less than 5°, and in particular advantageously less than 2°.

The term “wiper” is preferably understood to mean at least a part, preferably a subassembly of a wiper unit. The wiper is preferably intended for use on a sensor, in particular a LiDAR sensor. Preferably, the wiper forms part of the wiper unit. Preferably, the wiper, in particular as part of the wiper unit, is designed for cleaning a surface, preferably a surface of the sensor, particularly preferably the sensor field surface. The wiper is preferably coupled to the sensor, preferably to a wiper drive of the sensor, for cleaning the sensor field surface. For this purpose, the wiper can comprise a wiping lip or a wiper blade with a wiping lip, which is swept over a surface of the sensor, preferably over the sensor field surface, during a cleaning process. An “operating state” is preferably intended to mean a state in which the wiper unit, preferably the wiper, is ready for operation for a wiping process and/or a wiping operation and/or is in a wiping operation, in which the wiper, preferably a wiping lip, of the wiper, in particular of the wiper unit, is preferably guided over a sensor field surface and thereby advantageously bears against the sensor field surface. In particular, mechanical cleaning preferably displaces water and/or dirt particles by a wiping movement over a surface. In particular, mechanical cleaning can be assisted by a cleaning fluid or gas stream or the like.

Preferably, the sensor field cleaning device is arranged and/or fixed and/or mounted on the sensor, in particular LiDAR sensor. It is conceivable that the sensor field cleaning device can be retrofitted, in particular on the sensor. The sensor is arranged on a vehicle, such as a passenger car, commercial vehicle, rail vehicle, ship, aircraft, or drone. The sensor field cleaning device, in particular the wiper of the sensor field cleaning device, is provided to clean the sensor field surface. In this context, the term “vehicle” is to be understood to mean in particular a means of transport on land, in the air and/or on water, e.g., a land vehicle, a water vehicle and/or an aircraft. The vehicle can be designed as an at least partially or fully autonomous driving vehicle.

In this context, the term “driver assistance sensor” is in particular understood as an optical sensor that monitors an environment of the vehicle and transmits it to a control unit of the vehicle. The vehicle control unit can calculate and/or issue control commands, warnings, advisories, or suggestions for vehicle operation based on the sensor data. Preferably, a measurement principle of the driving assistance sensor is based on a reception and/or emission of electromagnetic beams. In particular, the electromagnetic beams pass through the sensor field, especially the vehicle window and/or a protective cover of the sensor, before being received. In particular, after being emitted, the electromagnetic beams pass through the sensor field, especially the vehicle window and/or a protective cover of the sensor. It is conceivable that the sensor is provided for high-frequency distance and speed measurement for object detection and/or collision avoidance. The sensor can, e.g., be used to control and regulate autonomous, and/or computer-assisted operation of vehicles or to support manual driving operation, e.g., by a lane departure warning system, a parking assistant, a distance warning system, a hazard detection system, and many more. In particular, the optical sensor is designed as a LiDAR (Light Detecting and Ranging) sensor. It is also conceivable that the sensor, in particular one of the sensors, is designed as a radar sensor.

A “back-and-forth movement” of the wiper is to be understood in particular as a translatory movement which features at least one reversal of direction and in which a start and/or end position coincide. In particular, the back-and-forth movement is directed along a width from the sensor field. Preferably, the width is at least substantially parallel to the horizontal direction and/or at least substantially parallel to an installation plane, in particular to a substrate, of the vehicle. Alternatively, the back-and-forth movement could be directed along a height and/or along a depth and/or along a length and/or along a diagonal or in a direction that appears advantageous to the skilled person. Preferably, the back-and-forth movement of the wiper is free of pivoting movements of the wiper about a fixed or movable pivot axis.

It is further proposed that the wiper unit comprises a guide unit, which is configured to guide the back-and-forth movement of the wiper over the at least single-curved sensor field surface being cleaned. Advantageously, a cleaning performance can be optimized, since in particular the wiper is guided along the sensor field surface being cleaned, especially at a constant or defined distance. Advantageously, wear on the wiper, in particular the wiping lip from the wiper, can be reduced, since in particular the wiper is guided along the sensor field surface, in particular at a constant or defined distance. Preferably, the guide unit is provided to keep the wiper at a constant and/or defined distance from the sensor field surface during the back-and-forth movement of the wiper. Preferably, the guide unit limits movement from the wiper to a wiping movement in the direction of back-and-forth movement and/or in the direction of width from the sensor field. In particular, the guide unit limits a wiper movement to one degree of freedom, especially along the back-and-forth movement. Preferably, the guide unit is arranged adjacent to the sensor field when viewed on a main extension plane from the sensor field. The terms “provided” and/or “configured” are in particular intended to mean specifically programmed, designed, and/or equipped. The phrase “an object being provided for a specific function” is particular intended and/or configured to mean that the object fulfills and/or performs this specific function in at least one application and/or operating state.

It is further proposed that the guide unit comprises at least one rotary element. Advantageously, friction from the guide unit can be reduced, since in particular a rolling movement from the rotary element causes low friction, especially lower friction than a plain bearing. Preferably, the rotary element features at least one axis of rotation. Preferably, the rotary element is rotationally symmetrical about the at least one axis of rotation.

It is also proposed that the rotary element be designed as a interlocking wheel or roller. Advantageously, reliability and/or operational safety can be improved, since in particular the rotary element is held in the guide unit by the interlocking connection. Preferably, the rotary element is designed as a rolling element, such as a wheel or a roller or a barrel or a sphere or a cone or any other geometric shape of the rolling element that appears advantageous to the skilled person. Preferably, the rotary element comprises an interlocking element which is provided to form a guide rail of the guide unit with a corresponding interlocking element. Preferably, the interlocking element is arranged radially on the rotary element. For example, the interlocking element could be designed as at least one projection or recess tapering in the radial direction, in particular towards the outside. Preferably, the interlocking element limits movement from the rotary element in the axial direction. It is conceivable that the interlocking element is additionally or alternatively arranged in the axial direction. Preferably, the interlocking element of the rolling element is configured to hold at least the rolling element in a position predetermined by the guide rail and/or to guide it along the guide rail.

In addition, it is proposed that the guide unit comprises a guide rail unit with at least one at least single-curved guide rail. Advantageously, a function can be optimized because, in particular, guidance from the wiper can also be provided along a single-curved surface. Preferably, the curvature of the at least one guide rail at least substantially follows the course of curvature of the sensor field surface. Preferably, a main direction of extension from the guide unit is arranged at least substantially parallel to a back-and-forth movement of the wiper and/or to a width from the sensor field. For example, the guide unit comprises exactly one guide rail, which is provided to guide at least two, preferably at least three rotary elements. For example, the three rotary elements surround the guide rail from the outside. Alternatively, the guide unit could comprise at least two guide rails, which are provided to guide at least one, preferably at least two rotary elements, in particular in an interlocking manner, from the outside. In particular, at least the guide rail is fixed to the sensor by the guide unit. The expression “from the outside” is in this context intended to mean in particular an arrangement of at least one guided component between at least two guiding components, the at least one guided component being held and/or clamped and/or embraced and/or guided between the guiding components. The term “main direction of extension” of an object is in this context in particular understood to mean a direction which extends parallel to a longest edge of a smallest geometrical cuboid, which just completely encloses the object. In particular, the curvature of the guide rail corresponds approximately to the curvature of the sensor field surface.

It is further proposed that an axis of rotation of the at least one rotary element is fixed in a stationary manner relative to the guide rail unit or that the rotary element is arranged movably relative to the guide rail unit in the guide unit. Effective guiding properties can advantageously be achieved, especially with regard to wear and/or friction. The rotary element can be integrated and/or arranged in an interlocking manner in and/or on the guide unit. For example, a plurality of rotary elements, in particular side by side and/or one above the other and/or without contact with each other, could be arranged along the at least one guide rail and fixed in a stationary manner relative to the guide rail. For example, the axes of rotation of the rotary elements could be arranged/fixed to the at least one guide rail and/or to a housing of the sensor. For example, a wiper and/or a wiper arm support element from the wiper or a similar drive element could roll to a drive from the wiper on at least a majority of the rotary elements. For example, a circumferential speed from the rotary elements during the unwinding process at least substantially corresponds to a speed of the wiper.

Alternatively, the axis of rotation of the at least one rotary element could be arranged such that the axis of rotation of the at least one rotary element moves back and forth along the at least one guide rail, in particular at the speed of the wiper. In this exemplary embodiment, the rotary element could roll on the at least one guide rail. Preferably, the guide unit is arranged on at least two, in particular opposite, sides from the sensor field surface. Preferably, the same number of rotary elements are arranged on at least two sides of the sensor field surface. Preferably, the guide unit is designed and/or arranged at least substantially mirrored on the sensor field surface. Alternatively, it is conceivable that the wiper is arranged in a cantilevered manner, whereby the wiper is fixed exclusively to a guide unit arranged on one side of the sensor field surface. The term “axis of rotation” is in particular understood to mean an axis, in particular an axis of symmetry of a rotationally symmetrical body, about which the body is rotated.

It is further proposed that an axis of rotation of the rotary element extends at least substantially parallel to the main direction of extension of the wiper, or that the axis of rotation of the rotary element extends at least substantially perpendicular to the main direction of extension of the wiper. Preferable properties with regard to a function can advantageously be provided, since in particular a particularly stiff/rigid/precise positioning from the wiper to the sensor field surface is possible, since in particular a force perpendicular to the sensor field surface can be absorbed by the rotary element. Advantageously, a function can be improved since, in particular, with an axis of rotation arranged at least substantially perpendicular to the main direction of extension of the wiper, a change in path of the rotary element, in particular of the wiper, which is guided over the rotary element, perpendicular to the sensor field surface is possible. For example, the axis of rotation of the at least one rotary element extends at least substantially parallel to the main direction of extension of the wiper and/or at least substantially parallel to the axis of curvature of the sensor field surface and/or at least substantially vertical. For example, the axis of rotation extends at least substantially perpendicular to the main direction of extension of the wiper and/or at least substantially perpendicular to the sensor field surface.

It is further proposed that the guide unit comprises at least one further rotary element, the rotary element and the further rotary element being arranged in the guide unit in such a way that they surround the guide rail at least on two sides, or that the guide rail unit forms a guide cage at least for at least one rotary element, in particular at least for the rotary element. Particularly preferable properties can advantageously be provided with regard to guidance, since in particular a movement can be limited by the wiper in at least two spatial directions. Advantageously, guidance can be improved because, in particular, an interlocking connection can be made between the guide rail and the at least two rotary elements. Advantageously, operational safety can be increased, since in particular the at least one rotary element and/or the at least one further rotary element is integrated in the guide cage and is thus secured against falling out. Preferably, the rotary element and the further rotary element are at least substantially identical in construction and/or design. It is conceivable that the further rotary element is shorter/longer than the rotary element, in particular along the axis of rotation, and/or comprises a further element, e.g., an interlocking element and/or a friction reduction element. Alternatively, the further rotary element could be of a different design from the rotary element, such as a ball and/or a wheel and/or a cone and/or a barrel or the like. For example, at least the two axes of rotation of the two opposite rotary elements surrounding the guide rail are arranged parallel to each other. In particular, the further rotary element features a direction of rotation opposite to that of the rotary element during back-and-forth movement of the wiper. For example, at least the two opposing rotary elements surrounding the guide rail are fixedly, in particular rigidly, connected to each other. Alternatively, two guide rails could surround one and/or two, in particular at least two, rotary elements. For example, the axis of rotation of at least the rotary element and/or the further rotary element is arranged parallel to the main direction of extension of the wiper. Preferably, the axis of rotation of at least the rotary element and/or the further rotary element is arranged perpendicular to the main direction of extension of the wiper. For example, the guide cage at least substantially partially surrounds the rotary element and/or the further rotary element. For example, at least one rotary element and/or at least one further rotary element is arranged in the guide cage. For example, the guide cage extends at least substantially parallel to the main extension plane from the sensor field surface. Alternatively, the guide cage could also run along the sensor field surface.

In addition, it is proposed that the guide unit comprises at least one wiper arm support element, which is configured to fix a wiper arm of the wiper unit and, in particular, to guide a movement of the wiper arm along the sensor field surface, in particular in a width direction of the sensor field surface. Advantageously, a high level of stability and/or good guiding properties can be achieved because the wiper arm support element in particular features a high level of rigidity. Advantageously, repair costs can be reduced because the wiper in particular can be replaced if necessary without having to replace the entire wiper unit. Advantageously, a cleaning performance can be improved because, in particular during a wiper movement in a width direction, water and/or water droplets and/or dirt particles or the like are wiped off to the side and are not smeared over the sensor surface during the back-and-forth movement. Preferably, the wiper arm support element is provided to receive the wiper. Preferably, the wiper arm support element is provided to move the wiper and/or transmit a drive movement to the wiper. Preferably, the wiper arm support element is at least partially arranged in the guide cage. For example, the at least one rotary element and/or the at least one further rotary element is fixed in a stationary manner to the wiper arm support element. For example, the axis of rotation of the at least one rotary element and/or the at least one further rotary element moves along the sensor field surface at least substantially at the speed of the wiper. For example, a plurality of rotary elements and/or further rotary elements are arranged in the guide cage. In particular, the wiper arm support element rolls on the rotary elements and/or the further rotary elements.

Preferably, the wiper arm support element comprises a quick-release fastener that is configured to fix the wiper to the wiper arm support element, in particular without tools by plug and play. In this context, a “width direction” is to be understood as a direction that extends along a wiper movement, in particular along and/or parallel to the back-and-forth movement of the wiper and/or along the sensor field surface. Preferably, the width direction extends at least substantially perpendicular to the axis of curvature of the sensor field surface.

It is also proposed that the wiper unit comprises a contact pressure unit which is configured to maintain a minimum contact pressure of the wiper against the sensor field surface being cleaned during wiper operation, in particular in each wiper position of the wiper during wiper operation. Advantageously, reliability can be improved, in particular because the minimum contact pressure required for optimum cleaning can be ensured in every operating condition. In particular, exactly the minimum contact pressure is applied in at least one edge region, which is defined by a start and/or end position and/or a helical position of the wiper. Preferably, the guide unit extends parallel to a main extension plane from the sensor field surface. Preferably, a contact pressure force increases with increasing distance of any desired point on the sensor field surface from the guide unit. In particular, a “minimum contact pressure” is to be understood as a force per surface which is applied at least in every possible operating condition.

It is further proposed that the contact pressure unit comprises a pretensioning unit, for example with at least one spring element, by means of which a pretensioned change in length of a part of the wiper unit, in particular of a wiper arm of the wiper unit, is made possible. Advantageously, reliability can be improved, in particular because the minimum contact pressure required for optimum cleaning can be ensured in every operating condition. Preferably, the spring element is designed as a helical tension spring. Alternatively, the spring element could be designed as a torsion spring or as a hydraulic or pneumatic spring element.

In addition, a sensor, in particular a driving assistance sensor, e.g. LiDAR sensor, with a sensor field cleaning device is proposed. Advantageously, a reliability in an operation of the LiDAR sensor can be improved and/or a maintenance interval can be extended, since in particular no impairment of a function by an insufficient cleaning of the sensor field occurs any more. Preferably, the sensor field cleaning device is arranged on the LiDAR sensor, in particular on a housing of the LiDAR sensor. It is conceivable that the sensor field cleaning device is fixed to a vehicle that comprises the LiDAR sensor.

Further proposed is a vehicle, in particular at least partially autonomously driving vehicle comprising a sensor. Advantageously, safety can be improved, since in particular a malfunction due to insufficient cleaning can be prevented from the sensor field surface of the LiDAR sensor.

Further proposed is a method for cleaning at least one sensor, in particular a driving assistance sensor, e.g. a LiDAR sensor, of a vehicle, in particular by means of a sensor field cleaning device, by means of which, in at least one method step, an at least single-curved sensor field surface of the sensor is cleaned by a wiper unit comprising a wiper by means of a back-and-forth movement of the wiper, in particular at least mechanically, preferably directly. Cleaning of the single-curved sensor field surface can advantageously be enabled, since in particular the sensor field surface is cleaned by the back-and-forth movement from the wiper.

The sensor field cleaning device according to the invention, the sensor according to the invention, the vehicle according to the invention and the method according to the invention are not intended here to be limited to the application and embodiment described above. In particular, the sensor field cleaning device according to the invention, the sensor according to the invention, the vehicle according to the invention and the method according to the invention can comprise a number of individual elements, components and units as well as method steps different from a number mentioned herein for fulfilling a mode of operation described herein. Moreover, regarding the ranges of values indicated in this disclosure, values lying within the aforementioned limits are also intended to be considered as disclosed and usable as desired.

### BRIEF DESCRIPTION OF THE DRAWINGS

Further advantages follow from the description of the drawings hereinafter. The drawings illustrate six exemplary embodiments of the invention. The drawings, the description, and the claims contain numerous features in combination. The skilled person will appropriately also consider the features individually and combine them into additional advantageous combinations.

Shown are:

FIG. 1 a schematic view of a vehicle with a sensor,

FIG. 2 a schematic perspective view of the sensor with a sensor field cleaning device,

FIG. 3 a schematic view of the sensor with the sensor field cleaning device comprising a guide unit in a top view,

FIG. 4a a schematic view of a rotary element of the guide unit,

FIG. 4b a schematic view of an alternative embodiment of the rotary element of the guide unit

FIG. 5 a schematic flowchart of a method for cleaning a sensor field of the sensor by means of the sensor cleaning device,

FIG. 6 a guide unit of a first alternative sensor field cleaning device,

FIG. 7 a guide unit of a second alternative sensor field cleaning device,

FIG. 8 a guide unit of a third alternative sensor field cleaning device,

FIG. 9 a guide unit of a fourth alternative sensor field cleaning device,

FIG. 10 a fifth alternative sensor field cleaning device; and

FIG. 11 a schematic flow diagram of an alternative method for cleaning a sensor field of the sensor using the sensor cleaning device,

### DETAILED DESCRIPTION

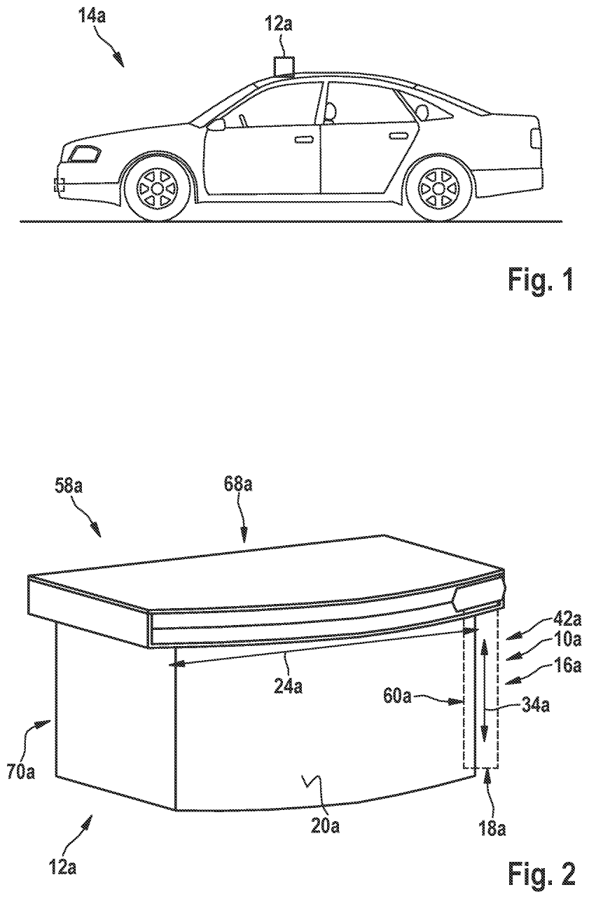

FIG. 1 shows a schematic representation of a vehicle 14a. The vehicle 14a is designed as an autonomous or semi-autonomous vehicle 14a. The vehicle 14a is designed as a passenger car. The vehicle 14a could also be designed as a utility vehicle. The vehicle 14a comprises a sensor 12a. The sensor 12a is arranged within a roof region from the vehicle 14a. The sensor 12a could also be arranged within a front region or other location of the vehicle 14a. The sensor 12a is designed as a driver assistance sensor. The sensor 12a is designed as a LiDAR sensor.

FIG. 2 shows a schematic perspective view of the sensor 12a. The sensor 12a comprises a housing 58a. The housing 58a is provided to protect the sensor 12a from environmental influences, e.g., rain, snow, damage, dirt or the like. The housing 58a encloses the sensor 12a and electrical, optical, electronic or similar elements such as cables, circuit boards, optical elements, or the like. The housing 58a comprises a housing cover 68a. The housing 58a comprises a sensor housing 70a. The housing cover 68a partially forms the housing 58a. The housing cover 68a overhangs the sensor housing 70a. The sensor housing 70a partially forms the housing 58a. The sensor 12a comprises a single-curved sensor field surface 20a. The sensor field surface 20a defines a measurement area from the sensor 12a. The sensor field surface 20a is formed as a portion of the housing 58a. The sensor field surface 20a is designed to be transparent. The sensor field surface 20a could also be partially transparent, such as tinted, or designed to be translucent only for certain wavelength ranges. The sensor field surface 20a faces in a main direction of travel from the vehicle 14a. It is conceivable that the sensor field surface 20a is oriented in a direction different from the main direction of travel of the vehicle 14a. Furthermore, it is conceivable that the direction of the sensor field surface 20a is designed to be changeable, such as alignable by a rotation of the sensor 12a. A sensor field cleaning device 10a is arranged on the sensor 12a. The sensor field cleaning device 10a is arranged on the housing 58a of the sensor 12a. The sensor field cleaning device 10a is arranged on the housing cover 68a. The sensor field cleaning device 10a is arranged on a side of the sensor 12a opposite/away from the vehicle 14a. The sensor field cleaning device 10a is partially arranged within the housing 58a from the sensor 12a. The sensor field cleaning device 10a is provided for cleaning the sensor 12a. The sensor field cleaning device 10a is provided for cleaning from the single-curved sensor field surface 20a. The sensor field cleaning device 10a comprises a wiper unit 16a. The wiper unit 16a comprises a wiper arm 42a. The wiper arm 42a is partially arranged within the housing 58a. The wiper arm 42a extends through a movable opening. The wiper unit 16a comprises a wiper 18a. The wiper unit 16a is configured to clean the single-curved sensor field surface 20a of the sensor 12a by means of a back-and-forth movement of the wiper 18a. The back-and-forth movement extends along/direction of a width 24a from the sensor field surface 20a. Cleaning of the sensor field surface 20a by means of the wiper 18a is performed mechanically and/or directly. The wiper 18a comprises a wiping lip 60a. The wiping lip 60a from the wiper 18a is in contact with the sensor field surface 20a in any operating condition. The wiping lip 60a contacts the sensor field surface 20a.

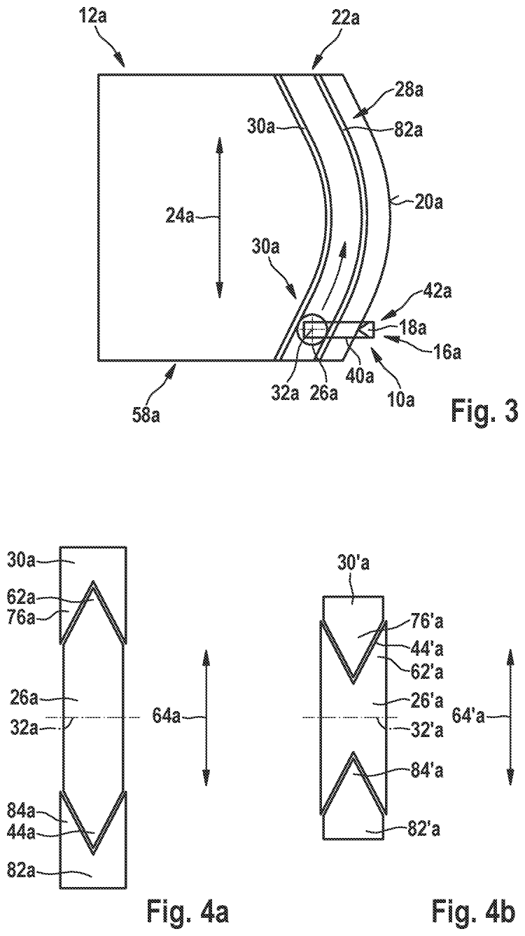

FIG. 3 shows a schematic representation of the sensor 12a with the sensor field cleaning device 10a comprising the wiper unit 16a in a top view. The wiper unit 16a comprises a guide unit 22a. The guide unit 22a is configured to guide the back-and-forth movement of the wiper 18a over the curved sensor field surface 20a being cleaned. The guide unit 22a comprises a guide rail unit 28a. The guide rail unit 28a comprises a single-curved guide rail 30a. The guide rail unit 28a comprises another single-curved guide rail 82a. The single-curved guide rail 30a extends along a curvature of the single-curved sensor field surface 20a. The further single-curved guide rail 82a extends along a curvature of the single-curved sensor field surface 20a. The guide rail 30a, the further guide rail 82, and the single-curved sensor field surface 20a are arranged in a parallel curve to each other. The guide rail 30a and the further guide rail 82a extend along/directionally of a width 24a from the sensor field surface 20a. The guide rail 30a and the further guide rails 82a are designed in one piece. The guide rail 30a and the further guide rail 82a could be fixedly connected to each other via a connecting element 78a or via the housing 58a. The guide rail 30a and the further guide rail 82a are arranged adjacent to the sensor field surface 20a when viewed on the sensor field surface 20a. The guide rail 30a and the further guide rail 82a are arranged above the sensor field surface 20a as viewed in the vertical direction. Alternatively, another guide unit 22a could be arranged in the vertical direction below the sensor field surface 20a. The guide rail 30a and the further guide rail 82a are arranged on the same side of the sensor field surface 20a when viewed on the sensor field surface 20a.

The guide unit 22a comprises a wiper arm support element 40a. The wiper arm support element 40a is configured to fix the wiper arm 42a of the wiper unit 16a. The wiper arm support element 40a is configured to guide and transmit a movement of the wiper arm 42a along the sensor field surface 20a in a direction of the width 24a of the sensor field surface 20a. The guide unit 22a comprises a rotary element 26a. The rotary element 26a is designed as a rolling element. The rotary element 26a is designed as an interlocking wheel. The rotary element 26a could also be designed as a roller, or a barrel, or a cone, or a comparable shape that would appear to be advantageous to the skilled person. The rotary element 26a comprises an axis of rotation 32a. The axis of rotation 32a of the rotary element 26a extends parallel to a main direction of extension 34a of the wiper 18a (see FIG. 2).

FIG. 4a shows an exemplary embodiment of the rotary element 26a. The rotary element 26a is configured to rotate about the axis of rotation 32a. The rotary element 26a is arranged between the guide rail 30a and the further guide rail 82a. The rotary element 26a comprises an interlocking element 62a. The interlocking element 62a is configured to form an interlocking connection with a corresponding interlocking element 76a on the guide rail 30a. The interlocking element 62a is provided to form an interlocking connection with a further corresponding interlocking element 84a on the further guide rail 82a. The interlocking element 62a is arranged on an outer diameter of the rotary element 26a. The interlocking element 62a features a tapered shape in a radial direction 64a of the rotary element 26a. The interlocking element 62a is designed as a radially outwardly pointing tip 44a. The guide rail 30a and the further guide rail 82a surround the interlocking element 62a of the rotary element 26a. Alternatively, the interlocking element 62a could comprise two or more radially outwardly pointing tips. Alternatively, the interlocking element 62a could also be round in design or feature another geometric shape that appears advantageous to the skilled person. Alternatively, the interlocking element 62a could be arranged in an axial end face from the rotary element 26a.

FIG. 4b shows an alternative exemplary embodiment of the rotary element 26′a. The rotary element 26′a is configured to rotate about the axis of rotation 32′a. The rotary element 26′a is arranged between the guide rail 30′a and the further guide rail 82′a. The rotary element 26′a comprises an interlocking element 62′a. The interlocking element 62′a is provided to form an interlocking connection with a corresponding interlocking element 76′a on the guide rail 30′a. The interlocking element 62′a is configured to form an interlocking connection with a further corresponding interlocking element 84′a on the further guide rail 82′a. The interlocking element 62′a is arranged on the outer diameter of the rotary element 26′a. The interlocking element 62′a features a tapered shape in a radial direction 64′a of the rotary element 26′a. The interlocking element 62′a is designed as a radially inwardly pointing tip 44′a. The interlocking element 62′a of the rotary element 26′a surrounds the guide rail 30′a and the further guide rail 82′a. Alternatively, the interlocking element 62′a could also comprise two or more radially inwardly pointing tips. Alternatively, the interlocking element 62′a could also be round or feature another geometric shape that appears advantageous to the skilled person. Alternatively, the interlocking element 62′a could also be arranged on an axial end face of the rotary element 26′a.

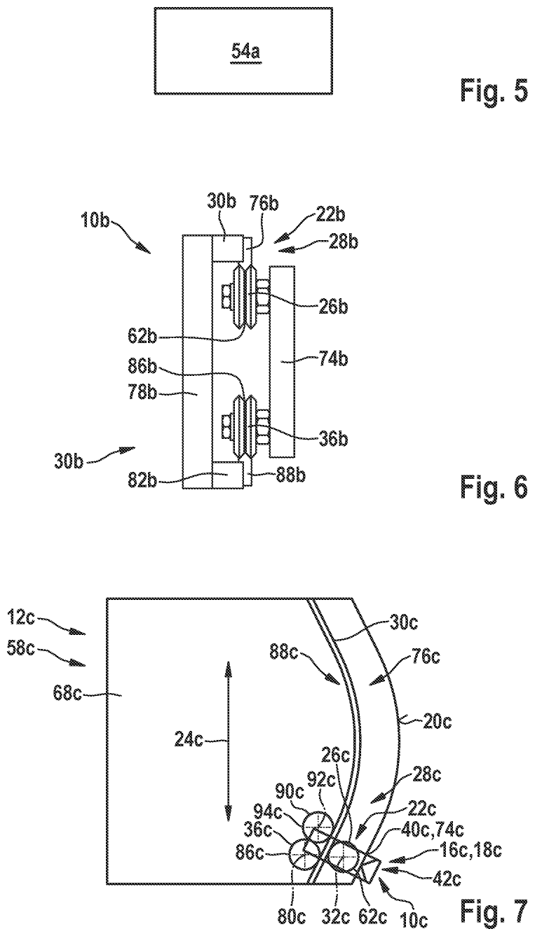

FIG. 5 shows a schematic flow diagram of a method for cleaning the sensor 12a using the sensor field cleaning device 10a. In a method step 54a, a wiper unit 16a comprising a wiper 18a directly mechanically cleans an at least singly-curved sensor field surface 20a of the sensor 12a by means of a back-and-forth movement of the wiper 18a. Cleaning from the sensor field surface 20a can be performed at different wiper speeds. Cleaning from the sensor field surface 20a can be performed at different cleaning intervals. For cleaning, the wiper 18a is guided along the sensor field surface 20a, contacting the sensor field surface 20a. For this purpose, the wiper 18a is guided from a rest position in the direction of the width 24a from the sensor field surface 20a. In an end position, the wiper 18a experiences a reversal of direction and is moved back to the start position/rest position.

FIGS. 6 to 11 show further exemplary embodiments of the invention. The following descriptions and the drawings are substantially limited to the differences between the exemplary embodiments, whereby, with respect to identically designated components, in particular with respect to components having the same reference characters, reference can in principle also be made to the drawings and/or the description of the other exemplary embodiments, in particular in FIGS. 1 to 5. In order to distinguish between the exemplary embodiments, the letter a is appended to the reference characters for the exemplary embodiment in FIGS. 1 to 5. In the exemplary embodiments of FIGS. 6 to 11, the letter a is replaced by the letters b to f.

FIG. 6 shows a first alternative sensor field cleaning device 10b. The first alternative sensor field cleaning device 10b is provided to clean a single-curved sensor field surface 20b from a sensor 12b. The sensor field cleaning device 10b comprises a wiper unit 16b. The wiper unit 16b comprises a guide unit 22b. The guide unit 22b comprises a guide rail unit 28b with a guide rail 30b and another guide rail 82b. The guide rail 30b and the further guide rail 82b extend along a curvature of the single-curved sensor field surface 20b. The guide rail 30b, the further guide rail 82b and the single-curved sensor field surface 20b are arranged in a parallel curve to each other. The guide unit 22b comprises a rotary element 26b. The guide unit 22b comprises a further rotary element 36b. The rotary element 26b and the further rotary element 36b are designed as two wheels. The rotary element 26b engages with the guide rail 30b. The further rotary element 36b engages with the further guide rail 82b. The guide rail 30b and the further guide rail 82b are fixedly connected to each other by a connecting element 78b. Alternatively, the guide rail 30b and the further guide rail 82b could also be designed in one piece. Alternatively, the guide rail 30b and the further guide rail 82b could be connected via a housing cover 68b of the sensor 12b. The rotary element 26b and the further rotary element 36b are fixedly connected to each other via a further connecting element 74b. The further connecting element 74b is configured to fix the wiper unit 16b of the guide unit 22b. The further connecting element 74b is configured to position/fix the rotary element 26b and the further rotary element 36b relative to each other. The rotary element 26b comprises an interlocking element 62b. The further rotary element 36b comprises a further interlocking element 86b. The interlocking element 62b is arranged on a radially outward side of the rotary element 26b. The interlocking element 62b comprises two tips. The interlocking element 62b of the rotary element 26b is configured to form an interlocking connection with a corresponding interlocking element 76b of the guide rail 30b. The further interlocking element 86b is arranged on a radially outward side of the further rotary element 36b. The further interlocking element 86b comprises two tips. The further interlocking element 86b of the further rotary element 36b is configured to form an interlocking connection with a further corresponding interlocking element 88b of the guide rail 82b. The rotary element 26b and the further rotary element 36b are of identical design. The guide rail unit 28b surrounds the rotary element 26b and the further rotary element 36b from two opposite sides. The rotary element 26b and the further rotary element 36b are arranged at a distance from each other. Alternatively, in addition to the rotary element 26b and the further rotary element 36b, the guide unit 22b could comprise any desired number of further rotary elements that the skilled person would consider advantageous.

FIG. 7 shows a schematic diagram of a second alternative sensor field cleaning device 10c. The first alternative sensor field cleaning device 10c is provided to clean a single-curved sensor field surface 20c from a sensor 12c. The sensor field surface 20c features a width 24c. The sensor field cleaning device 10c comprises a wiper unit 16c. The wiper unit 16c comprises a wiper 18c. The wiper unit 16c comprises a guide unit 22c. The guide unit 22c comprises a guide rail unit 28c. The guide rail unit 28c comprises a guide rail 30c. The guide rail 30c extends along a curvature of the single-curved sensor field surface 20c. The guide rail 30c and the single-curved sensor field surface 20c are arranged in a parallel curve to each other. The single-curved guide rail 30c is arranged on a housing 58c of the sensor 12c. The single-curved guide rail 30c is arranged on a housing cover 68c of the sensor 12c. The guide rail 30c comprises a corresponding interlocking element 76c. The guide rail 30c comprises another corresponding interlocking element 88c. The corresponding interlocking element 76c is arranged on a side of the guide rail 30c facing the sensor field surface 20c and/or a wiper arm 42c of the wiper unit 16c. The further corresponding interlocking element 88c is arranged on a side of the guide rail 30c facing away from the sensor field surface 20c and/or the wiper arm 42c of the wiper unit 16c. The guide unit 22c comprises a wiper arm support element 40c. The wiper arm support element 40c is configured to fix the wiper arm 42c of the wiper unit 16c. The guide unit 22c comprises a rotary element 26c. The guide unit 22c comprises a first further rotary element 36c and a second further rotary element 90c. Alternatively, the guide unit 22c could comprise more than one rotary element 26c. Alternatively, the guide unit 22c could comprise more than the two rotary elements 36c, 90c. The rotary element 26c and the two further rotary elements 36c, 90c are designed as wheels. The rotary element 26c is arranged on a side of the guide rail 30c facing the sensor field surface 20c and/or the wiper arm 42c. The two further rotary elements 36c, 90c are arranged on the side of the guide rail 30c facing away from the sensor field surface 20c and/or the wiper arm 42c. Alternatively, the rotary element 26c could also be arranged on the side of the guide rail 30c facing away from the sensor field surface 20c and/or the wiper arm 42c. Alternatively, the two further rotary elements 36c, 90c could also be arranged on the side of the guide rail 30c facing the sensor field surface 20c and/or the wiper arm 42c. The rotary element 26c features an axis of rotation 32c. The axis of rotation 32c is arranged parallel to the wiper arm 42c. The axis of rotation 32c is arranged parallel to the sensor field surface 20c. The first further rotary element 36c features a first further axis of rotation 80c. The second further rotary element 90c features a second further axis of rotation 92c. The axis of rotation 32c and the first further axis of rotation 80c and the second further axis of rotation 92c are arranged parallel to the wiper arm 42c. The axis of rotation 32c and the first further axis of rotation 80c and the second further axis of rotation 92c are arranged parallel to the sensor field surface 20c. The rotary element 26c comprises an interlocking element 62c. The first further rotary element 36c comprises a first further interlocking element 86c. The second further rotary element 90c comprises a second further interlocking element 94c. The rotary element 26c and the first further rotary element 36c and the second further rotary element 90c are connected to each other via a connecting element 74c. The connecting element 74c is configured to position the rotary element 26c and the first further rotary element 36c and the second further rotary element 90c with respect to each other and with respect to the guide rail 30c. The connecting element 74c holds the interlocking connections between the rotary element 26c, the first further rotary element 36c, the second further rotary element 90c, and the guide rail 30c.

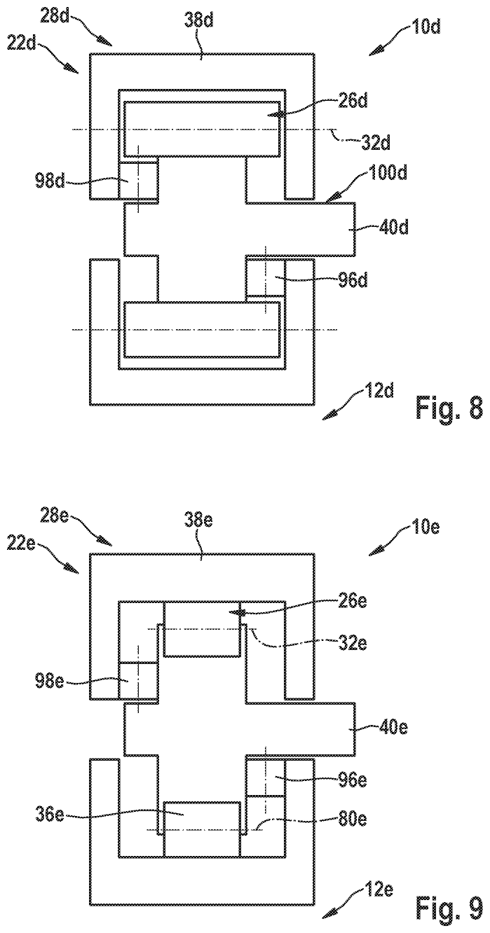

FIG. 8 shows a schematic diagram of a third alternative sensor field cleaning device 10d. The third alternative sensor field cleaning device 10d is provided to clean a single-curved sensor field surface 20d from a sensor 12d. The sensor field cleaning device 10d comprises a wiper unit 16d. The wiper unit 16d comprises a wiper 18d. The wiper unit 16d comprises a wiper arm 42d. The wiper unit 16d comprises a guide unit 22d. The guide unit 22d comprises a guide rail unit 28d. The guide unit 22d comprises a wiper arm support element 40d. The wiper 18d is fixed to the wiper arm support element 40d via the wiper arm 42d. The guide unit 22d comprises a plurality of rotary elements 26d. All rotary elements 26d are of identical design. Each rotary element 26d features an axis of rotation 32d. Each axis of rotation 32d of each of the rotary elements 26d extends perpendicular to a main direction of extension 34d of the wiper 18d. Each axis of rotation 32d of each of the rotary elements 26d extends perpendicular to a width of the sensor field surface 20d. The axis of rotation 32d of the rotary element 26d is fixed in a stationary manner relative to the guide rail unit 28d. The rotary elements 26d are spaced along a width 24d of the sensor field surface 20d. The guide unit 22d comprises the same number of rotary elements 26d on the side of the wiper arm support element 40d facing away from the sensor 12d as on the side of the wiper arm support element 40d facing the sensor 12d. Alternatively, the guide unit 22d could comprise a different number of rotary elements 26d on the side of the wiper arm support element 40d facing away from the sensor 12d compared to the side of the wiper arm support element 40d facing the sensor 12d. The guide unit 22d comprises a spacer element 96d. The guide unit 22d comprises a further spacer element 98d. The spacer element 96d and the further spacer element 98d are arranged on two opposite sides of the wiper arm support element 40d. The spacer element 96d and the further spacer element 98d are provided to guide the wiper arm support element 40d perpendicular to the main direction of extension of the wiper 18d along the width 24d of the sensor field surface 20d. The spacer element 96d is designed as a roller. The further spacer element 98d is designed as a roller. Alternatively, the spacer element 96d and the further spacer element 98d could be designed as a sliding block. The spacer element 96d and the further spacer element 98d are of identical design. The spacer element 96d and the further spacer element 98d are rotatably fixed to the wiper arm support element 40d. The guide unit 22d comprises a guide rail unit 28d. The guide rail unit 28d forms a guide cage 38d for the rotary element 26d and the further rotary element 36d. The wiper arm support element 40d is movably arranged in the guide cage 38d along the width 24d of the sensor field surface 20d. The guide rail unit 28d features a main direction of extension. The main direction of extension from the guide rail unit 28d is arranged parallel to a main extension plane from the sensor field surface 20d. The guide unit 28d comprises a passage opening 100d, which is configured to guide the wiper arm support element 40d through the guide cage 38d for fixing of the wiper arm 42d.

FIG. 9 shows a schematic diagram of a fourth alternative sensor field cleaning device 10e. The fourth alternative sensor field cleaning device 10e is a variation of the exemplary embodiment shown in FIG. 8. The following descriptions and the drawings are substantially limited to the differences between the fourth alternative sensor field cleaning device 10e and the third alternative sensor field cleaning device 10d shown in FIG. 8. The fourth alternative sensor field cleaning device 10e is provided to clean a single-curved sensor field surface 20e of a sensor 12e. The fourth alternative sensor field cleaning device 10e comprises a wiper unit 16e. The wiper unit 16e comprises a guide unit 22e. The guide unit 22e comprises a wiper arm support element 40e. The guide unit 22e comprises a rotary element 26e. The rotary element 26e features an axis of rotation 32e. The guide unit 22e comprises a further rotary element 36e. The further rotary element 36e features a further axis of rotation 80e. The axis of rotation 32e and the further axis of rotation 80e are arranged parallel to each other. The axis of rotation 32e and the further axis of rotation 80e are arranged perpendicular to a main direction of extension of the sensor field surface 20e. The rotary element 26e is rotatably fixed to the wiper arm support element 40e. The rotary element 36e is rotatably fixed to the wiper arm support element 40e. The rotary element 26e is arranged on the side of the wiper arm support element 40e facing away from the sensor 12e. The further rotary element 36e is arranged on the side of the wiper arm support element 40e facing the sensor. The axis of rotation 32e of the rotary element 26e and the further axis of rotation 80e of the further rotary element 36e are arranged movably relative to the guide rail unit 28e in the guide unit 22e.

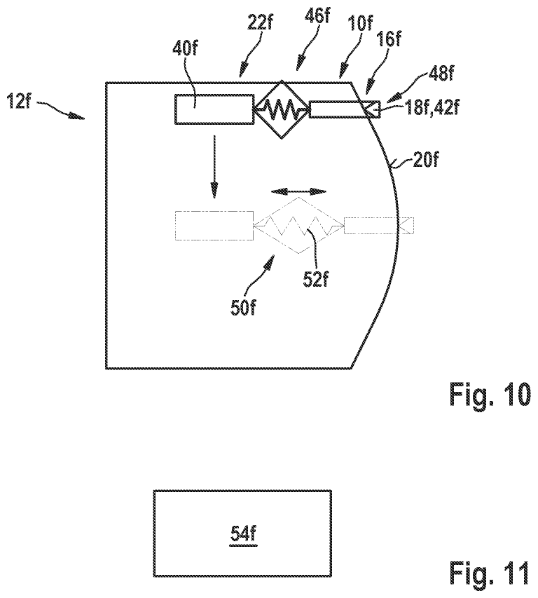

FIG. 10 shows a schematic diagram of a fifth alternative sensor field cleaning device 10f. The fifth alternative sensor field cleaning device 10f comprises a wiper unit 16f. The wiper unit 16f comprises a wiper 18f. The wiper unit 16f comprises a wiper arm 42f. The wiper unit 16f comprises a guide unit 22f. The guide unit 22f comprises a wiper arm support element 40f. The wiper 18f is fixed to the wiper arm 42f. The wiper unit 16f comprises a contact pressure unit 46f. The wiper arm 42f is fixed to the wiper arm support element 40f via the contact pressure unit 46f. The contact pressure unit 46f is configured to maintain, by means of a sensor 12f, a minimum contact pressure of the wiper 18f against a sensor field surface 20f being cleaned during wiper operation, at each wiper position 48f of the wiper 18f during wiper operation. The contact pressure unit 46f comprises a pretensioning unit 50f. The pretensioning unit 50f comprises a spring element 52f. The spring element 52f enables a pretensioned change in length of a portion of the wiper unit 16f of the wiper arm 42f of the wiper unit 16f. The pretensioning unit 50f is, e.g., designed as a spring-pretensioned telescope. The pretensioning unit 50f could also be designed as a similar spring-pretensioned mechanism, such as a spring-pretensioned toggle mechanism.

FIG. 11 shows a schematic flow diagram of a method for cleaning the sensor 12f using the sensor field cleaning device 10f.

In method step 54f, a wiper unit 16f comprising a wiper 18f directly mechanically cleans an at least single-curved sensor field surface 20f of the sensor 12f by means of a back-and-forth movement of the wiper 18f. For cleaning, the wiper 18f is moved along the sensor field surface 20f, contacting the sensor field surface 20f. For cleaning, the wiper arm support element 40f is moved back and forth along the guide cage 38f. For this purpose, the wiper 18f is guided from a rest position in the direction of the width 24f from the sensor field surface 20f. In an end position, the wiper 18f experiences a reversal of direction and is moved back to the start position/rest position. As the wiper 18f moves from the rest position toward the end position, the distance from the wiper arm support element 40f to the sensor field surface 20f increases. As the distance between the wiper arm support element 40f and the sensor field surface 20f increases, the contact pressure unit 46f is deflected more. The further the contact pressure unit 46f is deflected, the greater a contact pressure force of the wiper arm support element 40f on the sensor field surface 20f becomes. At the center of the sensor field width 24f, there is a shortest distance between the wiper arm support element 40f and the sensor field surface 20f, and therefore the pressure between the wiper 18f and the sensor field surface 20f is greatest.

1. A sensor field cleaning device (10a; 10b; 10c; 10d; 10e; 10f) for cleaning at least one sensor (12a; 12b; 12c; 12d; 12e; 12f) of a vehicle (14a; 14b; 14c; 14d; 14e; 14f), the device comprising a wiper unit (16a; 16b; 16c; 16d; 16e; 16f), which comprises at least one wiper (18a; 18b; 18c; 18d; 18e; 18f), wherein the wiper unit (16a; 16b; 16c; 16d; 16e; 16f) is configured to clean an at least single-curved sensor field surface (20a; 20b; 20c; 20d; 20e; 20f) of the sensor (12a; 12b; 12c; 12d; 12e; 12f) by a back-and-forth movement of the at least one wiper (18a; 18b; 18c; 18d; 18e; 18f).

2. The sensor field cleaning device (10a; 10b; 10c; 10d; 10e; 10f) according to claim 1, wherein the wiper unit (16a; 16b; 16c; 16d; 16e; 16f) comprises a guide unit (22a; 22b; 22c; 22d; 22e; 22f), which is configured to guide the back-and-forth movement of the at least one wiper (18a; 18b; 18c; 18d; 18e; 18f) over the at least single-curved sensor field surface (20a; 20b; 20c; 20d; 20e; 20f) being cleaned.

3. The sensor field cleaning device (10a; 10b; 10c; 10d; 10e; 10f) according to claim 2, wherein the guide unit (22a; 22b; 22c; 22d; 22e; 22f) comprises at least one rotary element (26a; 26b; 26c; 26d; 26e; 26f).

4. The sensor field cleaning device (10a; 10b; 10c; 10d; 10e; 10f) according to claim 3, wherein the rotary element (26a; 26b; 26c; 26d; 26e; 26f) is configured as an interlocking wheel, or as a roller.

5. The sensor field cleaning device (10a; 10b; 10c; 10d; 10e; 10f) according to claim 2, wherein the guide unit (22a; 22b; 22c; 22d; 22e; 22f) comprises a guide rail unit (28a; 28b; 28c; 28d; 28e; 28f) comprising at least one at least single-curved guide rail (30a; 30b; 30c; 30d; 30e; 30f).

6. The sensor field cleaning device (10d; 10e; 10f) according to claim 3, wherein an axis of rotation (32d; 32f) of the rotary element (26d; 26f) is fixed in a stationary manner relative to a guide rail unit (28d; 28f), or wherein the rotary element (26e; 26f) is arranged to be movable relative to the guide rail unit (28e; 28f) in the guide unit (22e; 22f).

7. The sensor field cleaning device (10a; 10b; 10c; 10d; 10e; 10f) according to claim 3, wherein an axis of rotation (32a; 32b; 32c;) of the rotary element (26a; 26b; 26c;) extends at least substantially parallel to a main direction of extension (34a; 34b; 34c) of the at least one wiper (18a; 18b; 18c), or wherein the axis of rotation (32d; 32e; 32f) of the rotary element (26d; 26e; 26f) extends at least substantially perpendicular to the main direction of extension (34d; 34e; 34f) of the at least one wiper (18d; 18e; 18f).

8. The sensor field cleaning device (10c; 10d; 10e; 10f) according to claim 3, wherein the guide unit (22c) comprises at least one further rotary element (36c) distinct from the at least one rotary element (26c), wherein the at least one rotary element (26c) and the at least one further rotary element (36c) are arranged in the guide unit (22c) such that they surround a guide rail (30c) at least on two sides, or wherein a guide rail unit (28d; 28e; 28f) at least forms a guide cage (38d; 38e; 38f) for at least one rotary element (26d; 26e; 26).

9. The sensor field cleaning device (10a; 10b; 10c; 10d; 10e; 10f) according to claim 2, wherein the guide unit (22a; 22b; 22c; 22d; 22e; 22f) comprises at least one wiper arm support element (40) which is configured to fix a wiper arm (42a; 42b; 42c; 42d; 42e; 42f) of the wiper unit (16a; 16b; 16c; 16d; 16e; 16f) and to guide a movement of the wiper arm (42a; 42b; 42c; 42d; 42e; 42f) along the sensor field surface (20a; 20b; 20c; 20d; 20e; 20f).

10. The sensor field cleaning device (10d; 10e; 10f) according to claim 1, wherein the wiper unit (16d; 16e; 16f) comprises a contact pressure unit (46d; 46e; 46f) which is configured to operate during wiper operation to maintain a minimum contact pressure of the at least one wiper (18d; 18e; 18f) on the sensor field surface (20d; 20e; 20f) being cleaned.

11. The sensor field cleaning device (10d; 10e; 10f) according to claim 10, wherein the contact pressure unit (46d; 46e; 46f) comprises a pretensioning unit (50d; 50e; 50f) having at least one spring element (52d; 52e; 52f), by which a pretensioned change in length of a part of the wiper unit (16d; 16e; 16f) is enabled.

12. A sensor (12a; 12b; 12c; 12d; 12e; 12f) comprising a sensor field cleaning device (10a; 10b; 10c; 10d; 10e; 10f) according to claim 1.

13. A vehicle (14a; 14b; 14c; 14d; 14e; 14f) comprising a sensor (12a; 12b; 12c; 12d; 12e; 12f) according to claim 12.

14. A method for cleaning at least one sensor (12a; 12b; 12c; 12d; 12e; 12f) of a vehicle (12a; 12b; 12c; 12d; 12e; 12f) using a sensor field cleaning device (10a; 10b; 10c; 10d; 10e; 10f) according to claim 1, wherein in at least one method step (54a; 54b; 54c; 54d; 54e; 54f), an at least single-curved sensor field surface (20a; 20b; 20c; 20d; 20e; 20f) of the sensor (12a; 12b; 12c; 12d; 12e; 12f) is cleaned by a wiper unit (16a; 16b; 16c; 16d; 16e; 16f) comprising a wiper (18a; 18b; 18c; 18d; 18e; 18f) by a back-and-forth movement of the wiper (18a; 18b; 18c; 18d; 18e; 18f).

15. The sensor field cleaning device (10a; 10b; 10c; 10d; 10e; 10f) according to claim 1, wherein the sensor is a driving assistance sensor.

16. The sensor field cleaning device (10a; 10b; 10c; 10d; 10e; 10f) according to claim 1, wherein the sensor is a LiDAR sensor.

17. The sensor field cleaning device (10a; 10b; 10c; 10d; 10e; 10f) according to claim 1, wherein the at least one wiper (18a; 18b; 18c; 18d; 18e; 18f) engages the at least single-curved sensor field surface (20a; 20b; 20c; 20d; 20e; 20f) mechanically.

18. The sensor field cleaning device (10a; 10b; 10c; 10d; 10e; 10f) according to claim 1, wherein the at least one wiper (18a; 18b; 18c; 18d; 18e; 18f) engages the at least single-curved sensor field surface (20a; 20b; 20c; 20d; 20e; 20f) directly.

19. The sensor field cleaning device (10a; 10b; 10c; 10d; 10e; 10f) according to claim 9, wherein, the at least one wiper arm support element (40) guides the movement of the wiper arm (42a; 42b; 42c; 42d; 42e; 42f) along the sensor field surface (20a; 20b; 20c; 20d; 20e; 20f) in a width direction (44a; 44b; 44c; 44d; 44e; 44f) of the sensor field surface (20a; 20b; 20c; 20d; 20e; 20f).
